(19) United States
(12) Patent Application Publication
(10) Pub. No.: US 2012/0176536 A1
(43) Pub. Date: Jul. 12, 2012

(54) Adaptive Frame Rate Conversion

(76) Inventors: Avi Levy, Kiryat Tivon (IL); Konstantin Levit-Gurevich, Kiryat Byalik (IL)

(21) Appl. No.: 13/004,930

(22) Filed: Jan. 12, 2011

(51) Int. Cl. H04N 7/01

(52) U.S. Cl. 348/441; 348/E07.003

(57) ABSTRACT

In accordance with some embodiments, frame rate conversion may use both forward and backward local and global motion estimation. Variable block sizes may be used for motion estimation by analyzing similarities between smaller block sizes.

### BACKGROUND

This relates generally to processing video information.

Video may be supplied with a given frame rate. The video is made up of a sequence of still frames. The frame rate is the number of frames per second.

Some displays use frame rates different than the frame rate of the input video. Thus, frame rate conversion converts the frame rate up or down so that the input frame rate matches the display's frame rate.

### BRIEF DESCRIPTION OF THE DRAWINGS

FIG. 1 is a block diagram for one embodiment;

FIG. 2 is a flow chart for adaptive frame rate conversion according to one embodiment;

FIG. 3 is a depiction of possible ways to split a block according to one embodiment;

FIG. 4 is a hypothetical graph of judder versus motion field variance;

FIG. 5 is a depiction of temporal and pyramid predictors in accordance with one embodiment of the present invention;

FIG. 6 is a depiction of a spatial predictor in accordance with one embodiment of the present invention; and

FIG. 7 is a system depiction for one embodiment.

### DETAILED DESCRIPTION

Frame rate conversion is used to change the frame rate of a video sequence. A typical frame rate conversion algorithm application is to convert film content from 24 frames per second to 60 frames per second for the National Television Systems Committee (NTSC) system or from 25 frames per second to 50 frames per second for the phase alternating line (PAL) system. High definition television supports 120 or 240 frames per second display, which also needs frame up conversion. In accordance with some embodiments, the frame rate conversion algorithm may adaptively compensate for the motion depicted in the video sequence.

In one embodiment, bi-directional, hierarchical local and global motion estimation and motion compensation is used. “Bi-directional” means that the motion is estimated between two anchor frames in the forward and backward directions. “Hierarchical motion estimation” refers to the fact that motion estimation is refined with each increasing resolution of the supplied video information. The bi-directional hierarchical local and global motion estimation is followed by a final motion compensation stage that integrates the two anchor frames and all motion estimation elements into one interpolation stage.

In accordance with one embodiment, an input series of two video frames may be received. The frames may include a series of pixels specified by x, y, and time t coordinates. Motion vectors may be determined from a first to a second frame and from the second to the first frame or, in other words, in the forward and backward directions. The algorithm creates an interpolated frame between the two frames using the derived local and global motion, the time stamp provided, and the consecutive frame data. The time stamp corresponds to the frame rate and, particularly, to the frame rate desired for the output frame.

Thus, a previous frame P may have pixels specified by x, y, and t variables and a next frame N may have pixels with x, y, and t+1 variables. The output frame C has pixels with x, y, t′ variables. Interpolated output frame C may have a time t+q, where q is less than 1 and greater than 0. Pixel positions may be indicated by p in an x and y coordinates. A motion vector MV_{AB} (x,y) is the motion vector, at coordinates x and y in screen space, from a frame A to a frame B. A global motion vector GM_{AB} is the dominant motion vector from frame A to frame B.

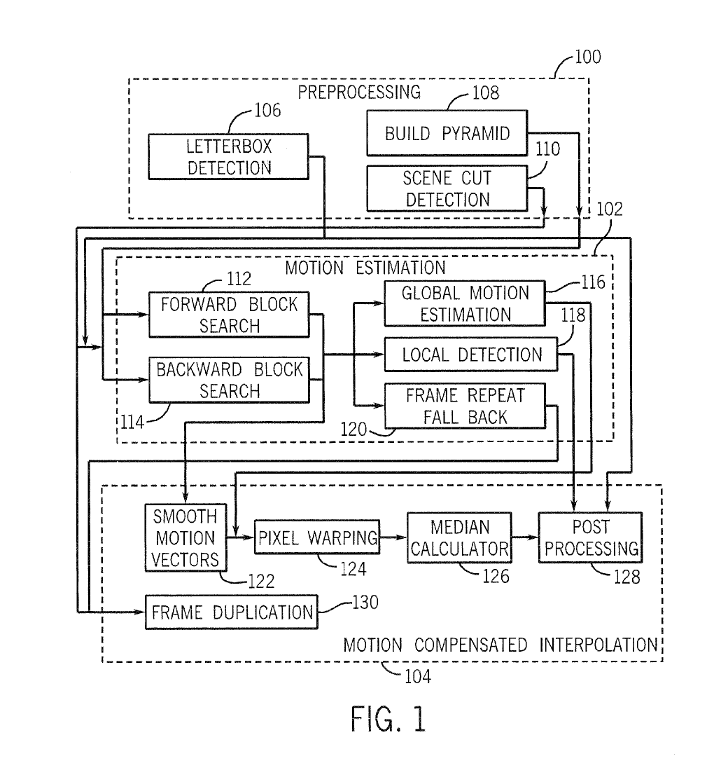

In accordance with some embodiments, the frame rate conversion is amenable to highly parallelized throughput computer devices such as multicore processors. It is also compatible with block search hardware accelerators. The frame rate converter, shown in FIG. 1, includes a preprocessing stage 100, a motion estimation stage 102, and a motion compensated interpolation stage 104. The preprocessing stage 100 operates on each original frame. The motion estimation stage 102 computes the forward and backward motion fields between each consecutive pair of original frames. The motion compensated interpolation stage 104 produces the interpolated frames to achieve the converted frame rate.

The preprocessing stage 100 includes letter box detection unit 106, pyramid building unit 108, and scene cut detection unit 110 in one embodiment. The letterbox detection unit 106 finds the black margins of the frames, if any such black margins exist. The scene cut detection unit 110 detects scene changes based on histogram features in one embodiment. The pyramid build 108 builds the pyramid structure of lower resolution versions of the frames.

In the letterbox detection unit 106, the black margins may be removed, which may otherwise interfere with the accuracy of motion estimation and, hence, are ignored during the block search process. The unit 106 computes independently the four coordinates of the active image regions inside the frame: firstX, firstY, lastX, and lastY, where X and Y are pixel coordinates. The firstX algorithm computes for each column, starting from the left one, in one embodiment, the average of the maximum and minimum grey level value of each pixel in YUV representation. The firstX algorithm tests a few criteria for a black color column. When, for the first time, one of these criteria is not met, the algorithm stops and the index of this column is output as the firstX. One set of criteria for a column to be part of a margin includes the determination that the maximum grey level value is not bigger than a threshold, the average grey level value is smaller than a threshold, the difference between the maximum and minimum values is smaller than a threshold, the difference between the average grey level value and the average value of the previous column is smaller than a threshold, and the difference between the average Y value and the average value of the same column in the previous frame is smaller than a threshold. The algorithms for lastX, firstY, lastY are essentially the same.

The scene cut detection unit 110 detects scene cuts by comparing the histogram of the next frame with that of the previous frame. When a scene cut is detected, the algorithm resets motion estimation buffers and changes the mode to frame duplicate. In the frame duplicate node, frames are simply duplicated instead of being interpolated. Thus, frames are duplicated at module 130 of the motion compensated interpolation stage 104 and the motion estimation stage 102 is simply skipped.

The build pyramid unit 108 is a standard image processing operation. The number of pyramid levels depends on the original frame resolution and may be determined in such a way that the lowest resolution level is not too small for block search operations.

The build pyramid unit 108 builds a pyramid structure for the Y component of a YUV depiction for an image where the lowest image of the pyramid is the original image, the second or lower resolution image is a quarter the size of the base unit or original image, and the third image is a still lower resolution image of the second image, a quarter of its size.

The motion estimation procedure may be the same in both the forward and backward directions. The motion estimation stage 102 uses the build pyramid block module 108, having a given number of levels. In one embodiment, three levels are utilized, but any number of levels may be provided. In order to achieve a smooth motion field, motion vector predictors from the previous level of a pyramid and from the previous motion estimation are used. The motion estimation output may include one motion vector for each 8×8 block in one embodiment.

In the motion estimation stage 102, the pyramids of the previous frame P and the next frame N are provided to a forward block search unit 112 and a backward block search unit 114. The output of each block search unit 112 and 114 is a motion vector field, either from the previous frame P to the next frame N, in the case of forward block search unit 112 or from the next frame to the previous frame, in the case of the backward block search unit 114, as depicted in FIG. 1. The global motion vector is the output of the block 116, and it is computed from the output of units 112 and 114. The motion vectors obtained from units 112 and 114 are provided in a granularity of 8×8 pixel blocks, in one embodiment, the smallest block size supported by the algorithm, in one embodiment. Even if we perform block search of 16×16 pixels block the output is still in 8×8 granularity. The results of the forward and backward motion estimation, together with the global motion vector, are provided to a motion compensation stage 104 which receives the motion vectors and the time q for the interpolated output frame C.

The motion estimation stage 102 may implement forward motion estimation or the backward motion estimation. It may be implemented in software or hardware. In a hardware embodiment, a hardware accelerator may be used in some embodiments.

The input frames A and B include only the Y component of a Y,U,V color system, in one embodiment. Other color schemes may also be used. The input to the motion estimation unit may also include temporal predictors for each block at each of a plurality of pyramid levels of a hierarchical system. Temporal predictors are the expected locations of a source block in a reference frame according to the previous motion estimation compute. The outputs are the motion vectors, as indicated, for each block at each pyramid level and the global motion or dominant motion vector in the frame.

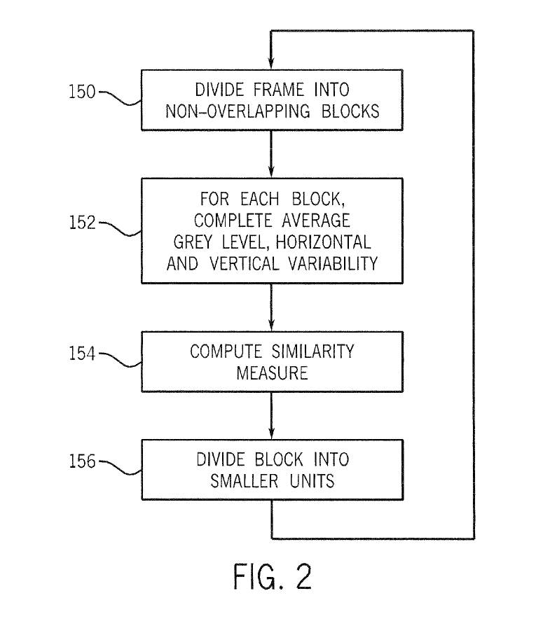

In some embodiments, an adaptive motion estimation may be implemented, as illustrated in FIG. 2. In order to make the estimation adaptive, the source frame may be divided into blocks of variable sizes. The initial size of a search block is determined by its sub-blocks' similarities and then the sub-block is divided again if a similarity measure, such as the sum of absolute difference (SAD) values, of the initial search is high.

The frame is divided into non-overlapping blocks (FIG. 2, block 150) of a given size, such as 16×16 pixels. Then, for such block, a similarity measure is computed for predetermined number of sub-blocks (e.g. four 8×8 sub-blocks). The average gray level:

$${Avg}_{B} = \frac{1}{64} {\sum }_{i = 0}^{7} {\sum }_{j = 0}^{7} Y ( i , j ) ,$$

the horizontal variability: and the

$${VarX}_{B} = \frac{1}{56} {\sum }_{i = 0}^{6} {\sum }_{j = 0}^{7} \vert Y ( i , j ) - Y ( i + 1 , j ) \vert ,$$

and the vertical variability:

$${VarY}_{B} = \frac{1}{56} {\sum }_{i = 0}^{6} {\sum }_{j = 0}^{7} \vert Y ( i , j ) - Y ( i , j + 1 ) \vert$$

are computed for deriving a similarity measure (block 152).

The similarity measure Sim_{a,b} (block 154) is determined as follows:

$${Sim}_{a , b} = \frac{\vert {Avg}_{a} - {Avg}_{b} \vert}{{Avg}_{a} + {Avg}_{b} + CA + 1} + \frac{\vert {VarX}_{a} - {VarX}_{b} \vert}{{VarX}_{a} + {VarX}_{b} + CX + 1} + \frac{\vert {VarY}_{a} - {VarY}_{b} \vert}{{VarY}_{a} + {VarY}_{b} + CY + 1}$$

where CA, CX and CY are empirical constants.

Based on these calculated similarity values, the original block is divided into sub-block configurations containing block sizes that are smaller than the original block size (block 156). The process may iterate, in some embodiments, to produce even smaller block sizes.

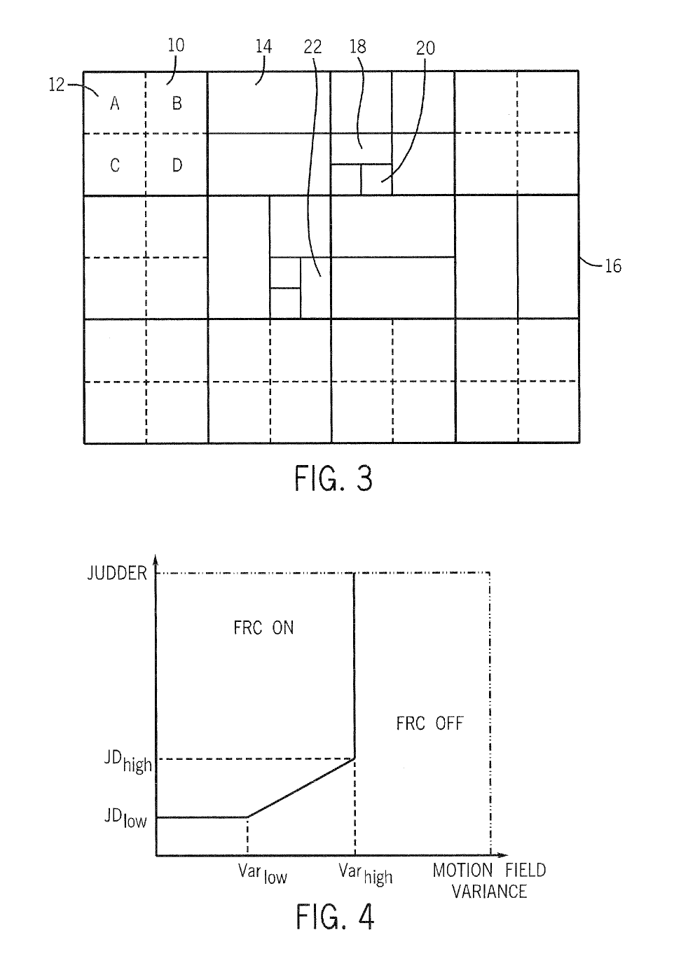

The sub-block size possibilities, in one embodiment, are illustrated in FIG. 3 in accordance with one embodiment. The possible block sizes include 16×16 block 10, 16×8 block 14, 8×16 block 16, 8×8, 8×4, 4×8, 4×4 block 12. The algorithm may give precedence to larger blocks if the similarities exist between their sub-blocks, in some embodiments. The output of this stage is the search block.

### Div=Split16×16Block(B)

Description:

The module decides about the division of a 16×16 block to 8×8 sub-blocks. It tries to keep the search blocks as large as possible as long as they have internal similarity.

Input:

B—the 16×16 block, consisting of B₀₀, B₁₀, B₀₁ and B₁₁, 8×8 sub-blocks

Output:

Div—(B₁, B₂, B₃, B₄)—division of the block B to four or fewer sub-blocks. When there are less than four sub-blocks the last ones are empty.

Process:

Compute the average gray level and the directional viabilities of the block B and the sub-blocks B₀₀, B₁₀, B₀₁ and B₁₁ according to:

Average gray value:

$${Avg}_{{B}_{i}} = \frac{1}{64} {\sum }_{i = 0}^{7} {\sum }_{j = 0}^{7} Y ( i , j )$$

Horizonatal variability

$${VarX}_{{B}_{i}} = \frac{1}{56} {\sum }_{i = 0}^{6} {\sum }_{j = 0}^{7} \vert B ( i , j ) - B ( i + 1 , j ) \vert$$

Vertical variability

$${VarY}_{{B}_{i}} = \frac{1}{56} {\sum }_{i = 0}^{6} {\sum }_{j = 0}^{7} \vert B ( i , j ) - B ( i , j + 1 ) \vert$$

Set the three constants ca, cb, cc (see the Similarity3 procedure below) to: ca=Avg_{B}, cb=VarX_{B}, cc=VarY_{B}.

```
// 16×16 block criteria
If for B₁₀, B₀₁ and B₁₁
    Similarity3 (VarX_{B0}, VarX_{Bij,} VarY_{B0}, VarY_{Bij,} Avg_{B0}, Avg _{Bij})
< sim_th
    DIV = (B,Φ,Φ,Φ)
    Finish
End if
// 8×16 and 16×8 sub-blocks
Sim01 = Similarity3 (VarX_{B00}, VarX_{B10,} VarY_{B00}, VarY_{B10,} Avg_{B00},
Avg _{B10})
Sim23 = Similarity3 (VARX_{B01}, VARX_{B11,} VarY_{B01}, VarY_{B11,} Avg_{B01},
Avg _{B11})
Sim02 = Similarity3 (VarX_{B00}, VarX_{B01,} VarY_{B00}, VarY_{B01,} Avg_{B00},
Avg _{B01})
Sim13 = Similarity3 (VarX_{B10}, VarX_{B11,} VarY_{B10}, VarY_{B11,} Avg_{B10},
Avg _{B11})
If Sim01 < sim_th and Sim23 < sim_th
    If Sim02 < sim_th and Sim13 < sim_th and
        //use two 8×16 blocks
        Sim01 + Sim23 > Sim02 + Sim13
        DIV = (B₀={B₀₀, B₀₁},B₁={ B₁₀, B₁₁},Φ,Φ)
        finish
    End if //use two 16×8 blocks
    DIV = ( B₀={B₀₀, B₁₀}, B₁={ B₀₁, B₁₁},Φ,Φ)
    Finish
End if
If Sim02 < sim_th and Sim13 < sim_th
    //use two 8×16 blocks
    DIV = ( B₀={B₀₀, B₀₁}, B₁={ B₁₀, B₁₁},Φ,Φ)
    Finish
End if
If Sim01 < sim_th and Sim23 >= Sim01 and Sim02 >= Sim01 and
Sim13 >= Sim01
    //use a 16×8 block
    DIV = ( B₀={B₀₀, B₁₀}, B₁=B₀₁, B₂=B₁₁,Φ)
    Finish
End if
If Sim23 < sim_th and Sim02 >= Sim23 and Sim13 >= Sim23
    //use a 16×8 block
    DIV = (B₀={B₀₁, B₁₁}, B₁=B₀₀, B₂=B₁₀,Φ)
    Finish
End if
If Sim02 < sim_th and Sim13 >= Sim02
    //use a 8×16 block
    DIV = (B₀={B₀₀, B₀₁}, B₁=B₁₀, B₂=B₁₁,Φ}
    Finish
End if
If Sim13 < sim_th
    //use a 8×16 block
    DIV = (B₀={B₁₀, B₁₁}, B₁=B₀₀, B₂=B₀₁,Φ}
    Finish
End if
//use 8×8 blocks
DIV = (B₀=B₀₀, B₁=B₁₀, B₃= B₀₁, B₄=B₁₁)
Finish
```

Sim=Similarity3(al, a2, b1, b2, c1, c2):

Description:

Measurement of similarity, based on 3 factors for two different blocks. Lower result indicates more similar blocks.

Input:

a1, a2, b1, b2, c1, c2—the factors to compare

Output:

Similarity3—the similarity factor of the blocks

Process:

$$Sim = \frac{\vert a 1 - a 2 \vert}{a 1 + a 2 + ca + 1} + \frac{\vert b 1 - b 2 \vert}{b 1 + b 2 + cb + 1} + \frac{\vert c 1 - c 2 \vert}{c 1 + c 2 + cc + 1}$$

where ca, cb, cc are constants.

Next, the motion estimation stage 102 prepares predictors for the search blocks. A predictor is a base motion vector that determines the central location of the reference frame, around which the search will be done. For each search block, a set of up to nine predictors may be calculated. Up to six predictors are inherited from the previous pyramid level motion vectors of neighboring blocks. In the highest pyramid level, there is only one spatial predictor, the zero vector. Up to five predictors may be inherited from the corresponding (forward or backward) preceding motion estimation stage. One is the global motion vector and the others are projected motion vectors of the sub-block in the same spatial location. Identical motion vectors may be removed from the predictor's set in order to reduce the search compute time, in some embodiments.

For each sub-block, of the source frame, that may be a sub-block of the search block, the magnitude of a similarity measure, such as sum of absolute differences of its motion vectors, is compared to a threshold. If the similarity value is larger than the threshold, then the block is further subdivided into sub-blocks. For these sub-blocks, a new set of predictors is computed and, for each one of them, the best motion vector is recomputed based on a new block search. If there are a number of predictors/candidates for the best vector, the one with the best sum of absolute differences (SAD) is chosen. If there are several candidates with the same SAD—the shortest one is chosen. If there are several candidates with the same SAD and the same length—an arbitrary one is chosen.

The global estimation module 116 estimates the global or dominant motion vector in the motion vector field computed by the forward and backward motion estimation modules 112 and 114. This may be done by an iterative process that computes the average motion vector and then removes the motion vectors that are distanced in the L¹ norm or Manhattan distance from the average. After the outliers are removed, the average is then computed again and another set of vectors is removed. The algorithm converges when no vectors are removed or when the majority of the vectors are very close to the average. The global motion vector is computed for the forward and backward directions. If these vectors differ, the one that has the smaller similarity measure on a small number of blocks is selected, in one embodiment.

The logo detection module 118 detects static solid or semitransparent logos or titles. The output of the logo detection module 118 is a logical array that indicates for each pixel in a frame if it belongs to a logo or title or not.

The frame repeat fallback module 120 makes a decision on the interpolation method of the motion compensated interpolation stage 104. Based on the distribution of motion vectors, the judder level and the scene cut indication, it computes a flag indicating frame repeat for the motion compensated interpolation stage 104. The criteria for using frame repeat, instead of motion compensated interpolation, may include very low judder level, large regions with high motion, and a large motion field variance. The judder level is estimated as the sum, over all the pixels in the frame, of the inner products of the gradient and the motion vector in one embodiment. However, pixels that have very fast motion or low inner product may be ignored. When the judder level is very low, motion compensated interpolation does not improve the video quality.

When a large percentage of the frame pixels have very high motion, the motion compensation interpolation may produce significant artifacts. Also, the human visual system is not sensitive to the judder artifacts when the motion is very high.

When the motion field has large variance, the motion compensated interpolation may produce significant artifacts that are more annoying than the judder artifacts. In order to produce smoother transitions between frame duplication and motion compensation modes and to avoid fast mode fluctuations, the algorithm may define a smooth decision region. The system may transition between the modes only if the mode indications are consistent for a few consecutive frames in one embodiment. In the beginning of a new scene, the frame rate conversion module is on (i.e. FRC on in FIG. 4). The mode is changed to motion compensation (i.e. FRC off in FIG. 4) if the frame repeat criteria are not fulfilled for a few consecutive frames. In the motion compensation mode, if, at a certain point in the scene, the frame repeat criteria are positive for a few consecutive frames, then the mode is changed to frame repeat and the system stays in this mode until the next scene change.

Thus, referring to FIG. 4, as an example, the frame repeat mode exists when the frame rate conversion is off (FRC OFF) and the motion compensation mode exists when the frame rate conversion is on (FRC ON). Thresholds for high judder (JD_{high}) and low judder (JD_{low}) are depicted, relative to motion field variance being low (VAR_{low}) or high (VAR_{high}).

The motion compensated interpolation stage 104 includes a motion vector smoothing 122, pixel warping 124, median calculator 126, post processing 128, and frame duplicate 130. The motion vector smoothing 122 computes forward and backward motion vectors for each pixel of the interpolated frame on the basis of the relevant block motion vectors. The motion vector of a given pixel is a weighted average of the motion vector of the block to which it belongs and the motion vectors of its immediate neighbor blocks. The weights are computed for each pixel based on its location in the block.

The pixel warping 124 computes four interpolation versions for each color component (Y, U, and V. for example) of each pixel of the interpolated frame. The interpolation versions may be pixel A=N(p+(1−q)·MV_{PN}(p)) from frame N in the location indicated by the corresponding motion vector from P to N and the time stamp q, pixel B=P(p+q·MV_{NP}(p)) from frame P in the location indicated by the corresponding motion vector from N to P and the time stamp q, pixel D=N(p+(1−q)·GM_{PN}) from frame N, in the location indicated by the global motion vector from P to N and the time stamp q, pixel E=P(p−q·GM_{PN}) from frame P in the location indicated by the global motion vector from N to P and the time stamp q. The method of interpolation, in one embodiment, may be nearest neighbor interpolation or bi-linear interpolation, as well as any other interpolation method.

Where locations are not at integer positions, the candidate pixel may be computed by using bilinear interpolation.

If a motion vector points to a pixel that is located outside the valid frame region, then the motion vector is truncated such that the valid pixel in the closest location is taken, in one embodiment, and this pixel is returned with a non-valid indication. Also, if a motion vector points to a location that one of its neighbors has a logo indication, then the motion vector is truncated to an integer position and this pixel is returned with a non-valid indication. In the median calculator 126, a non-valid pixel is replaced by the pixel from the other frame. If “pixel A” is not valid, then it is replaced by “pixel B” and the other way around. If both pixels are not valid, then the values that were returned are used. Denoting the four pixel candidates describes above as A, B, D, and E, in the corresponding order and where C equals (A+B)/2, the interpolated pixel is computed as the median of A, B, C, D, and E.

For pixels moving inside moving objects, the motion field is trusted and the values of the pixels A, B, and C are very close and, hence, they dominate the medium procedure. This is also true for pixels belonging to the background. However, for the points nearby, the objects' boundaries, the points A, B, and C may differ significantly. To reduce the halo effect of occlusion regions, the pixels D and E may be incorporated into the median.

The median calculator 126 calculates the median of A, B, C, D and E pixels for each component, such as Y, U, V of each pixel, where C is the average of A and B pixels.

The motion compensation block uses the P and N frames, including all Y, U, and V color components in a YUV system. It uses the forward motion vectors from P to N for the blocks of the lowest pyramid level (i.e. the level having the original resolution) only and the backward motion vectors from N to P for the blocks of the lowest pyramid level only. The forward global motion vector from P to N, and the backward global motion vector from N to P are used, as well as q, which is the time stamp of the interpolated frame and is a value between 0 and 1. The output is an interpolated frame.

In the post processing module 128, the logo detection logical array is scanned. In each position where there is a logo indication, the previously computed interpolated pixel is replaced by the average of the pixel in the previous frame and the pixel in the next frame at the same location as the interpolated pixel in some embodiments.

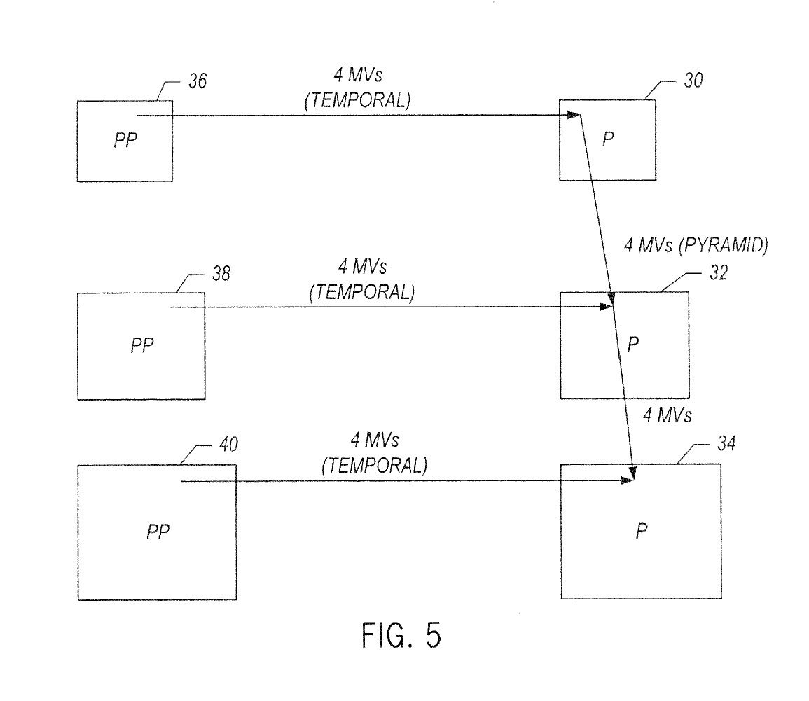

Referring to FIG. 5, a three level pyramid is depicted with the original image 30, the second level image 32, and the third level image 34. The blocks 30, 32, and 34, all denoted P for pyramid, indicate the three levels of the pyramid representation of the N frame. The three blocks 36, 38, and 40 are labeled PP for previous pyramids, stamped for the pyramid representation of the previous frame. Again, a predictor is the expected location of a source block in a reference frame. For each 8×8 block, one predictor is computed from the motion vector field of the previous frame, denoted temporal, in FIG. 5 and four predictors are computed from the previous, smaller level of the pyramid, as indicated in FIG. 5. At the highest pyramid level, the one with the lowest resolution, there is only one spatial predictor—the zero displacement.

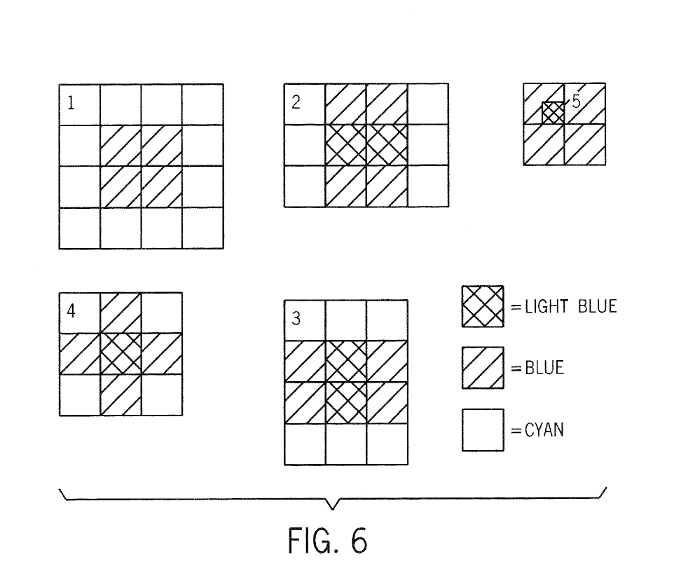

Referring to FIG. 6, the spatial predictors for (1) a 16×16 block, (2) a 8×16 block, (3) an 16×8 block, (4) an 8×8 block and (5) a 4×4 block. The light blue squares are the 8×8 (4×4 in item (5)) sub-blocks of the search block. All other squares are 8×8.

The algorithm for choosing the spatial predictors is as follows: for each case you need to choose the spatial predictors for the blocks with light blue color. Look at all blocks in FIG. 6 with blue colors and divide their coordinates by two. This action gives you the coordinates of the corresponding (4×4) block at the previous pyramid level. Take the motion vectors you calculated for the obtained blocks of the previous pyramid level, and double them in length. The resulting vectors are the required spatial predictors.

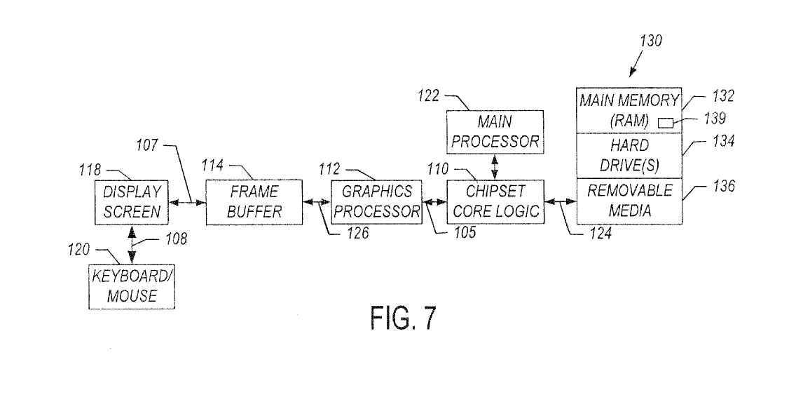

A computer system 130, shown in FIG. 7, may include a hard drive 134 and a removable medium 136, coupled by a bus 124 to a chipset core logic 110. The core logic may couple to a graphics processor 112 (via bus 105) and the main or host processor 122 in one embodiment. The graphics processor may also be coupled by a bus 126 to a frame buffer 114. The frame buffer 114 may be coupled by a bus 107 to a display screen 108, in turn, coupled to convention components by a bus 128, such as a keyboard or mouse 120. In the case of a software implementation, the pertinent computer executable code may be stored in any semiconductor, magnetic, or optical memory, including the main memory 132. Thus, in one embodiment, a code 139 may be stored in a non-transitory computer readable medium, such as main memory 132 for execution by a processor, such as a processor 112 or 122. In one embodiment, the code may implement the sequences shown in FIGS. 1 and 2.

In some embodiments, the bi-directional approach and using adaptive block size with the global motion vector may reduce the artifacts near object edges since these image regions are prone to motion field inaccuracy due to an aperture problem that arises in the one directional method.

While the aperture problem itself is not solved by the bi-directional approach, the final interpolation is more accurate since it relies on the best results from the two independent motion fields.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
performing frame rate conversion using blocks of variable sizes for motion estimation.

2. The method of claim 1 wherein said performing frame rate conversion includes using forward and backward motion estimation.

3. The method of claim 1 including dividing a frame into non-overlapping blocks.

4. The method of claim 3 including computing a similarity measure for sub-blocks within one of said blocks.

5. The method of claim 4 including, based on the similarity between sub-blocks, dividing said one of said blocks into sub-blocks.

6. The method of claim 5 including computing a similarity measure based on at least one of average gray level, horizontal variability, and vertical variability.

7. The method of claim 1 including automatically determining whether to use motion compensated interpolation or frame duplication.

8. A non-transitory computer readable medium storing instructions to enable a computer to:
perform frame rate conversion using blocks of variable sizes for motion estimation.

9. The medium of claim 8 further storing instructions to compute pixels based on interpolations using a forward motion vector and a backward motion vector.

10. The medium of claim 8 further storing instructions to analyze at least one of the distribution of motion vectors, judder level, and a scene cut indication, to determine whether to use motion compensated interpolation or frame duplication.

11. The medium of claim 8 further storing instructions to detect scene cuts for use in motion estimation.

12. The medium of claim 8 further storing instructions to use letterbox detection for motion estimation.

13. The medium of claim 8 further storing instructions to automatically determine whether to use motion compensated interpolation or frame duplication.

14. An apparatus comprising:
a frame rate conversion processor to use blocks of variable sizes for motion estimation; and
a storage coupled to said processor.

15. The apparatus of claim 14, said processor to use forward and backward motion estimation.

16. The apparatus of claim 14, said processor to divide a frame into non-overlapping blocks.

17. The apparatus of claim 16, said processor to compute a similarity measure for sub-blocks within one of said blocks.

18. The apparatus of claim 17, said processor to divide said one of said blocks into sub-blocks based on the similarity between sub-blocks.

19. The apparatus of claim 18, said processor to compute a similarity measure based on at least one of average gray level, horizontal variability, and vertical variability.

20. The apparatus of claim 14, said processor to automatically determine whether to use motion compensated interpolation or frame duplication.
